(19) United States
(12) Patent Application Publication
(10) Pub. No.: US 2004/0041682 A1
(43) Pub. Date: Mar. 4, 2004

(54) Battery circuit disconnect device

(76) Inventors: Brian D. Pasha, Cortland, OH (US); Terry A. George, Salem, OH (US); Raymond C. Culp, Austintown, OH (US)

Correspondence Address: THOMAS N. TWOMEY, DELPHI TECHNOLOGIES, INC., Legal Staff, Mail Code: 480-410-202, P.O. Box 5052, Troy, MI, 48007-5052, US

(21) Appl. No.: 10/230,837

(22) Filed: Aug. 29, 2002

(51) Int. Cl. H01H 39/00; H01H 71/20

(52) U.S. Cl. 337/401; 337/157

(57) ABSTRACT

A modular circuit disconnect device for connection in a circuit comprises a housing, a bus bar electrical conductor terminated on each end for connection in a circuit, an electrical conductor separator mechanism that uses kinetic energy to sever the electrical conductor, and an interface to accept a signal that indicates a condition requiring the electrical conductor to be severed. One embodiment utilizes a pyrotechnic device to sever a bus bar after receipt of a signal.

### TECHNICAL FIELD

The present invention relates to a device for opening a circuit.

### BACKGROUND OF THE INVENTION

Motor vehicles, such as cars, marine vessels, trucks and the like almost universally include a starter circuit and other cables that conduct high current. In many cases, such as in a starter circuit, it is impractical to protect the circuit with a fuse since a large fuse would be required to support the current needed to power the device. This size fuse would provide little or no protection during the periods of time when current is not needed to operate the device. As a result, in certain conditions, such as when wire insulation is cut or pierced, an unprotected circuit could cause electrical arcing or short circuits. This could shut down the vehicle or damage other components.

In addition, it may be advantageous to open a circuit in the event of a vehicle collision, short circuit, or some other event. A common solution is to use a large latching switch or contactor to disconnect selected battery circuits in the event of a post-crash short circuit. These types of devices are typically bulky and have reliability problems. The prior art includes examples of other devices. Richter, et al., German patent 4344639.6, the U.S. equivalent of which is U.S. Pat. No. 5,535,842 describes a device that slides over a battery cable and uses a pyrotechnic charge or spring force to cut a cable when initiated by an external signal. In certain applications, this device may require considerable force to cut through the cable and associated insulation. Therefore, it must be sized sufficiently large to enable enough energy to be stored to generate the required force. It also requires the cable to be repaired or replaced after an actuation. Krappel, et al., WO 97/31406, the U.S. equivalent of which is U.S. Pat. No. 6,171,121, describes a device that fires a pyrotechnic charge to dislodge a battery cable from a terminal attaching it to a battery. This device also requires the cable to be repaired or replaced after actuation. Another disadvantage is that the cable, separating mechanism, and pyrotechnic charge may not be contained during and after actuation creating risks associated with the rapidly moving ejected pieces. Totsuka, et al., Japanese patent 10-50978, the U.S. equivalent of which is U.S. Pat. No. 6,243,245 describes a forced-fusion fuse and circuit breaker that offers over-current circuit protection common to automotive fuses along with the ability to open the fuse based on input from a sensor. A disadvantage of this type of design in certain circuits is that surge current conditions can melt the fuse resulting in an unintended or nuisance opening of the circuit. Another disadvantage is in trade-offs that need to be made in sizing the fuse element to be large enough to avoid nuisance openings while being small enough to melt quickly when actuated.

### SUMMARY OF THE INVENTION

The present invention overcomes the problems noted above and satisfies a need for a circuit disconnect device. The present invention provides a housing that encloses and contains a current conducting bus bar and bus bar separator mechanism. Protruding from the housing are two terminals that provide electrical connection points for the circuit to be protected. In a preferred embodiment, a connection is provided for interface to an initiator circuit.

The separator mechanism is capable of being actuated by a signal indicating a need to open the circuit. Events that may trigger the signal include a crash sensor detecting a vehicle crash, a crash sensor detecting a vehicle crash in combination with an occupant detector such as a load cell detecting a trapped occupant, a theft system detecting a vehicle theft condition, detection of excessive current or other electrical fault, manual activation, and other events.

Upon being actuated, the separator mechanism uses kinetic energy to sever the bus bar and open the circuit. The separator mechanism may comprise a pyrotechnic charge, spring, solenoid, or other energy source acting on a blade or knife-like component. The separator mechanism may also comprise a flammable gas, compressed gas, or pyrotechnic charge that is sufficiently powerful to sever the bus bar electrical conductor without the need for a blade or knife-like component. The housing of the circuit disconnect device safely contains the mechanical components and any gas pressure generated during and after actuation.

In order to rapidly stop the supply of current it is desirable to cut or break the electrical conductor. The use of physical force is well suited for this, and in this invention is deemed the best solution. The use of physical force is referred to herein as being based on the use of kinetic energy. This is intended to include cutting, smashing, tearing, ripping, and substantially every known manner of causing physical force to result in causing the conductor to stop conducting.

The current conducting bus bar is designed with appropriate materials, size, and shape such that it carries sufficient current and is not susceptible to separation due to heating caused by excessive current flow. Ideally, the bus bar will not melt or otherwise open the protected circuit through any mechanism other than that caused by the separator mechanism. The bus bar is also designed such that it loses its ability to carry current after being acted upon by the separator mechanism. In a preferred embodiment, the bus bar is a rigid or semi-rigid rectangular shaped metal bar. The bus bar design may incorporate one or more weak points relative to the remainder of its length in an area where it is impacted by the separator mechanism. This could enable the size and mass of the separator mechanism as well as the overall device to be smaller and lighter than a unit required to cut through an insulated cable. This also enables a reduced amount of pyrotechnic, flammable gas, or other material that generates kinetic energy to be used as a separating mechanism with or without the use of a blade or knife-like component.

Once the device is activated, the electrical circuit remains permanently disconnected-until the activated circuit disconnect device is removed and replaced with an un-activated unit, or a component of the device is removed and replaced. For example, the bus bar can be replaced and a solenoid can be reset, a spring can be reset, and/or a pyrotechnic device can be reloaded. This would normally be done after clearing any circuit fault condition that caused activation.

Another embodiment of the present invention includes designing the overall electrical resistance of the bus bar conductor to a known resistance and incorporating a means to measure voltage across a length of the bus bar electrical conductor. The circuit disconnect device acts as a shunt resistor for measuring current in the protected circuit. In this embodiment, the circuit disconnect device further includes a control unit or means to communicate with an external control unit to activate the separator mechanism when the voltage differential across the bus bar electrical conductor exceeds a threshold amount. This allows the device to monitor for over-current conditions without the need for a separate current sensor.

### BRIEF DESCRIPTION OF THE DRAWINGS

The present invention will now be described, by way of example, with reference to the accompanying drawings, in which:

FIG. 1 is a sectional view of the battery circuit disconnect device of the present invention including an interface to an initiator circuit.

FIG. 2 is a sectional view of the battery circuit disconnect device of the present invention that uses a pyrotechnic for severing an electrical conductor.

FIG. 3 is a sectional view of another embodiment of the battery circuit disconnect device of the present invention utilizing the conductor as a shunt resistor.

### DETAILED DESCRIPTION OF THE INVENTION

Referring to the figures wherein like numerals refer to like elements throughout the several views, FIG. 1 illustrates a battery disconnect device 10 of the present invention. The housing 12 at least partially encloses an electrical conductor 14 having a first end 16 and a second end 18 adapted for connection in a circuit (not shown). The electrical conductor 14 comprises an electrically conductive bus bar 20 being in electrical contact with a first terminal 22 arranged at the first end 16 and being in electrical contact with a second terminal 24 arranged at the second end 18. The electrical conductor 14 is made of suitable materials and has sufficient cross-sectional area to adequately support the electrical load being supplied. In a preferred embodiment, the electrical conductor 14 has an indentation 26 to enable a predictable severing point and to reduce the amount of force needed to sever the electrical conductor 14. Note that an indentation is not required or more than one can be used. Also, note that the terminals 22, 24 are not required for the electrical conductor 14 to be adapted for connection in a circuit. For example, the electrical conductor 14 can be designed with formed terminals or it can be designed to be soldered or press fit to the protected circuit.

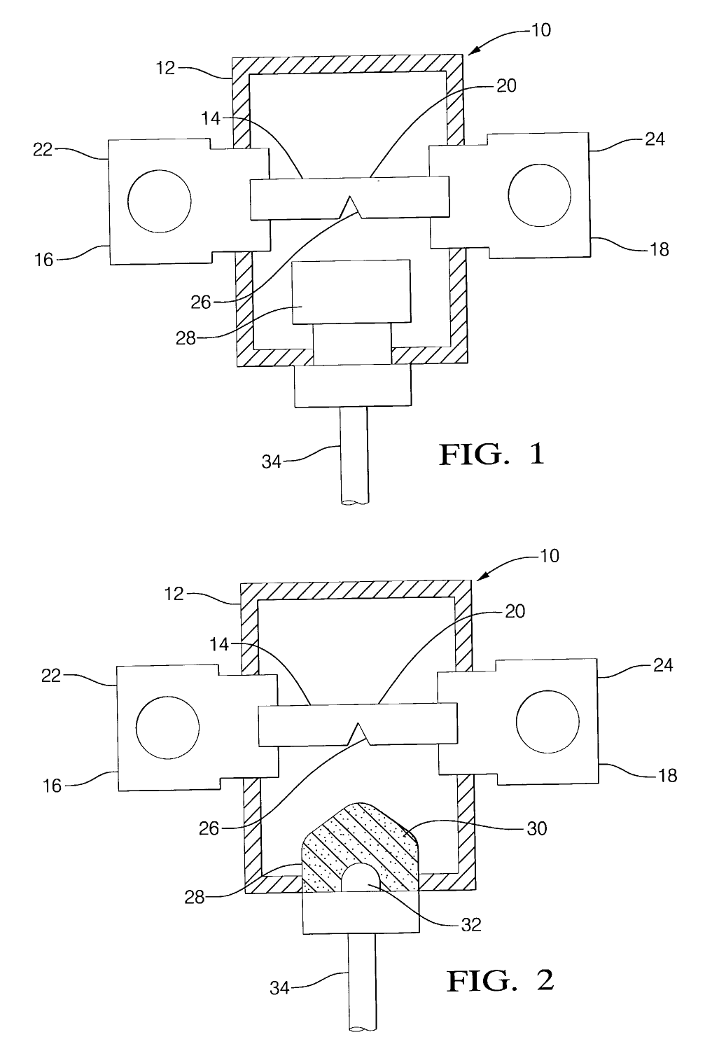

The housing 12 encloses an electrical conductor separator mechanism 28 capable of eliminating the current carrying capability of the electrical conductor 14 using kinetic energy. The separator mechanism 28 is capable of eliminating the current carrying capability of the electrical conductor 14 before rescue personnel arrive at the scene of an accident. FIG. 2 depicts the separator mechanism 28 comprising a pyrotechnic material 30 that can be ignited by a detonator 32. The use of the pyrotechnic material in the present invention can enable the current carrying capability of the electrical conductor to be eliminated in less than 1 millisecond after receiving the signal. Alternatively, the separator mechanism 28 may comprise a spring that propels a blade, a-flammable gas initiated by a detonator, a compressed gas, a solenoid, or other mechanism using kinetic energy.

Referring back to FIG. 1, the separator mechanism 28 is actuated by a signal from a line 34, which comprises one or more electrical circuits including a path to ground. Alternatively, the signal can be transmitted without the use of the line 34 using an infrared transmitter or other means. This may require additional structure within the battery disconnect device 10 to receive the signal, such as a radio frequency or infrared receiver or detector. The signal may originate from a control unit (not shown), sensor (not shown), or other source.

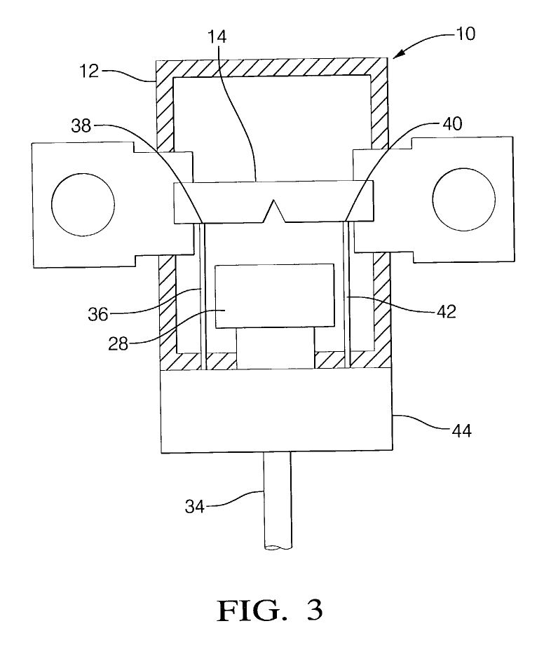

FIG. 3 illustrates another embodiment of the invention utilizing the electrical conductor 14 as a shunt resistor. In this embodiment, the battery disconnect device 10 comprises a housing 12, an electrical conductor 14, a separator mechanism 28, and the line 34 going to ground. The battery disconnect device further comprises a first voltage sense line 36 attached to a first voltage sense location 38 on the electrical conductor 14 and a second voltage sense line 42 attached to a second voltage sense location 40 on the electrical conductor 14. In this embodiment, the electrical conductor 14 between the first voltage sense location 38 and second voltage sense location 40 is designed to an appropriate known resistance value.

A control unit 44 measures and compares the voltages from the voltage sense lines 36, 42 and sends a signal to the separator mechanism 28 when a threshold voltage differential between the voltage sense lines 36, 42 is detected. This voltage differential corresponds to a known current. Thus, the control unit 44 signals the separator mechanism 28 to sever the electrical conductor 14 when a predetermined current is reached. Note, the control unit 44 is depicted as an integral part of the device. Alternatively, the control function can be performed by another module and signals transmitted between the other module and the battery disconnect device via the line 34.

This invention has been described with reference to the preferred embodiment and modifications thereto. Further modifications and alterations may occur to others upon reading and understanding the specification. It is intended to include all such modifications and alterations insofar as they come within the scope of the invention. For example, one skilled in the art would realize that where a signal is detected to initiate an event, the event can also be initiated by detecting a removal of a signal, or by detecting a change to a signal.

Having thus described the invention, it is claimed:

1. A modular circuit disconnect device for connection in a circuit comprising:
a housing;
an electrical conductor having a first end and a second end wherein at least a portion of said electrical conductor is within said housing and wherein each of said first end and said second end is adapted for connection in a circuit; and
a separator mechanism arranged within said housing, said separator mechanism being capable of eliminating the current carrying capability of said electrical conductor using kinetic energy.

2. A modular circuit disconnect device according to claim 1, wherein said separator mechanism comprises a pyrotechnic device.

3. A modular circuit disconnect device according to claim 1, wherein said separator mechanism comprises a blade.

4. A modular circuit disconnect device according to claim 1, wherein said separator mechanism comprises a solenoid.

5. A modular circuit disconnect device according to claim 1, wherein said separator mechanism comprises a gas.

6. A modular circuit disconnect device according to claim 1, wherein said housing is adapted to contain mechanical components of said separator mechanism after said separator mechanism has been actuated to eliminate the current carrying capability of said electrical conductor.

7. A modular circuit disconnect device according to claim 1, further comprising an initiator being capable of triggering said separator mechanism to eliminate the current carrying capability of said electrical conductor.

8. A modular circuit disconnect device according to claim 7, further comprising means to receive a signal.

9. A modular circuit disconnect device according to claim 8, wherein said separator mechanism is capable of eliminating the current carrying capability of said electrical conductor in less than 1 millisecond after receiving said signal.

10. A modular circuit disconnect device according to claim 1, further comprising means to measure a voltage differential across a length of said electrical conductor and means to trigger said separator mechanism when said voltage differential exceeds a predetermined amount.

11. A modular circuit disconnect device according to claim 1, further comprising:
a first voltage sense line having a first end being connected to a first voltage sense location on said electrical conductor;
a second voltage sense line having a first end connected to a second voltage sense location on said electrical conductor; and
a controller being connected to a second end of each of said first and second voltage sense lines, said controller being capable of measuring a voltage differential between said first and second voltage sense locations and said controller being further capable of generating a signal to trigger said separator mechanism to eliminate the current carrying capability of said electrical conductor when said voltage differential exceeds a predetermined amount.

12. A modular circuit disconnect device according to claim 1, wherein said electrical conductor comprises a bus bar.

13. A circuit disconnect device comprising:
an electrical conductor having a first end and a second end, wherein each of said first end and said second end is adapted for connection in a circuit;
a housing at least partially enclosing a length of said electrical conductor; and
a separator mechanism arranged within said housing, said separator mechanism being capable of separating said first end of said electrical conductor from said second end of said electrical conductor using kinetic energy.

14. A circuit disconnect device according to claim 13, wherein said separator mechanism comprises a pyrotechnic material.

15. A circuit disconnect device according to claim 14, further comprising means to receive a signal.

16. A circuit disconnect device according to claim 15, wherein said separator mechanism is capable of eliminating the current carrying capability of said electrical conductor in less than 1 millisecond after receiving said signal.

17. A circuit disconnect device according to claim 13, wherein said separator mechanism comprises a blade.

18. A circuit disconnect device according to claim 13, wherein said separator mechanism comprises a solenoid.

19. A circuit disconnect device according to claim 13, wherein said separator mechanism comprises a gas.

20. A circuit disconnect device according to claim 13, wherein said housing is adapted to contain mechanical components of said separator mechanism after said separator mechanism eliminates the current carrying capability of said electrical conductor.

21. A circuit disconnect device according to claim 13, further comprising an initiator being capable of triggering said separator mechanism to eliminate the current carrying capability of said electrical conductor.

22. A circuit disconnect device according to claim 13, wherein said electrical conductor comprises a bus bar.

23. A circuit disconnect device according to claim 13, further comprising means to measure a voltage differential across a length of said electrical conductor and means to trigger said separator mechanism when said voltage differential exceeds a predetermined amount.

24. A circuit disconnect device according to claim 13, further comprising:
a first voltage sense line having a first end being connected to a first voltage sense location on said electrical conductor;
a second voltage sense line having a first end connected to a second voltage sense location on said electrical conductor; and
a controller being connected to a second end of each of said first and second voltage sense lines, said controller being capable of measuring a voltage differential between said first and second voltage sense locations and said controller being further capable of generating a signal to trigger said separator mechanism to eliminate the current carrying capability of said electrical conductor when said voltage differential exceeds a predetermined amount.
